(19) United States
(12) Patent Application Publication
(10) Pub. No.: US 2012/0259732 A1
(43) Pub. Date: Oct. 11, 2012

(54) METHOD AND SYSTEM FOR LOCATING A PRODUCT IN A STORE USING A MOBILE DEVICE

(76) Inventors: Sanal Sasankan, Richmond (CA); Peng Fei Zhang, Surrey (CA)

(21) Appl. No.: 13/411,633

(22) Filed: Mar. 5, 2012

Related U.S. Application Data
(60) Provisional application No. 61/516,673, filed on Apr. 7, 2011.

(51) Int. Cl. G06Q 30/00; H04W 4/02

(52) U.S. Cl. 705/26.9

(57) ABSTRACT

A method of locating a product in a store using a mobile device is provided. The mobile device communicates with a store server through a local area network and retrieves location information for the product. Low granularity product and location information is received at the device from a store server as the user enters the store. Higher granularity location information is later received at the device depending on position of the device in the store. Pre-stored product choices in a shopping list application may be used to navigate to locations of successive products in the list.

### CROSS-REFERENCE TO RELATED APPLICATIONS

The present Application for Patent claims priority to Provisional U.S. Application Ser. No. 61/516,673 entitled “Method and system for locating a product in a store using a mobile device” filed Apr. 7, 2011, and expressly incorporated herein by reference.

### BACKGROUND

The patent relates to determining the location of a product in a store. More particularly, the patent discloses systems and methods of locating a product in a store using up-to-date product location information received at a mobile device.

Wireless communication devices have become ubiquitous in the modern world. Wireless devices, particularly mobile phones and “smart phones” offer significant advantages to users due to their size, mobility and nature of use. These characteristics have led to an ever-increasing number of uses that mobile devices are put to.

Identifying and locating desired products in large retail stores has always been a challenge. As retail stores expand in size and inventory, customers find it increasingly difficult to locate a product in the store. Customers have traditionally relied upon knowledge of the closest store-attendant to help them locate a product. However, the efficiency of such a mechanism depends on knowledge of the store attendant and the number of attendants available to assist the customer. The customer often has to walk down several aisles to find an attendant, which is time-consuming.

Existing solutions do not enable a customer to locally search for the location and availability of a desired product in the store, without sending product queries to a remote server. US 20080263125 discloses a method of locating products in a store by querying a remote server from a mobile device through the Internet. However, querying a remote data base in accordance with the teachings of the patent results in significant latency due to sending of queries through the Internet. The mobile device would also have to be Internet-capable, with a cellular data plan. Relatively high data charges continue to motivate mobile phone users to prefer a wireless local area network (WLAN) over cellular networks, for data communication. U.S. Pat. No. 7,819,315 discloses a system for locating a product in a store that comprises fixed terminals or handheld devices that are provided to the user. The device communicates with a database server to retrieve location information in response to a query. However, shoppers are generally reluctant to use fixed terminals or store-provided devices. Consumers prefer to use their personal mobile devices for navigation. Besides, a bandwidth-optimized delivery of product and location information is necessary considering the large number of products that can be found in a typical big-box retail store.

In view of the above, there is a need for systems that helps customers easily navigate the maze of products to identify their item of choice using personal mobile devices while ensuring that the perceived latency in receiving product information is minimized to enhance customer satisfaction.

### SUMMARY OF THE INVENTION

In view of the foregoing, a method of determining availability and location of products in a store is provided. A user may enter the name of a product of interest at a mobile device, which information is used by an application installed on the device to compare with a database of products maintained by the local store. The comparison provides information regarding the available quantities of the product as well as location information for the product. The mobile application determines the location of the user of the device and renders the user-location, location of the product and a map with a suggested path to reach the location. The product of interest may alternatively by identified through other means such as by referring to a shopping list stored in the mobile device.

According to one aspect of the invention, a complete product list and associated product-location information is sent to the device in a compressed format when the user enters a store. The information is stored locally in the device. The user may enter a query to search for availability and location information associated with a product of interest. An application installed on the device uses the saved product-location information and the current position of the user to compute a recommended path to the product, which is rendered on the store-map. Alternatively, at least one or more of the store-map, product list and the product-location information may be sent to the device any time after the customer enters the store. For instance, it would also be possible to send the information to the device in response to a query for a product.

According to a second aspect, information that is initially sent to the device during entry into the store is minimized to enhance the user experience. Only the updated product list for the store, the store-map and low-granularity location information is sent initially. The low-granularity location information may, in one embodiment, comprise the aisle number where a product can be found. A user, upon entering a product query close to the point of entry, will be able to identify the aisle where the product of interest is stored. As the user walks towards an aisle, high-granularity product-location information for that aisle is sent to the device. A richer and more detailed map is provided to help the user locate the product with greater precision. The mechanism permits location-based download of product-information to the device. The high-granularity information may be sent to the device in other ways. For instance, in one embodiment, the detailed map information is sent only for the aisle associated with a product query.

According to a third aspect, the user may download a store-map, the product list and associated location information for a particular store of interest through a personal computer before visiting the store. This method would particularly be beneficial to users of devices that do not feature radio modems for Wi-Fi or local area connectivity using IEEE 802.11 a/b/g or similar standards. In one embodiment the product location information may be downloaded by visiting the website of the retail outlet, selecting the store of interest and downloading metadata to the mobile device.

According to a fourth aspect, the product-list and associated location information for a particular store may be downloaded though a wireless wide area network such as GPRS, UMTS, LTE or CDMA 2000 mobile network.

According to a fifth aspect, the device receives the product list and associated location information when the user enters the store. The product location application may then refer to a pre-stored shopping list saved at the device to identify a first product choice of interest for which the location is to be determined. A second product choice may be identified from the shopping list when the device is detected to be within a predefined distance of the first product choice.

### BRIEF DESCRIPTION OF THE DRAWINGS

FIG. 1 shows an exemplary network deployment.

FIG. 2 shows block diagrams of a mobile device and a server, and messages exchanges there between entities when a complete product-list including location information of products is sent to the device.

FIG. 3 shows block diagrams of a mobile device and a server, and messages exchanges there between when product-location information is sent to the device based on where the device is located.

FIG. 4 is a flowchart that shows the steps taken in locating a product when complete product-location information is downloaded to the device.

FIG. 5 is a flowchart that shows the steps taken in locating a product when product-location information is sent to the device based on where the device is located.

FIG. 6 is an illustration of a store-map that is displayed on the user interface of the mobile device, with the store-map displaying low-granularity location information for a product of interest.

FIG. 7 is an illustration of a store-map that is displayed on the user interface of the mobile device, with the store-map displaying high-granularity location information for a product of interest.

FIG. 8 is an illustration of a store-map that shows the precise location of the product of interest after the device receives high-granularity location information and is positioned in close proximity to the product of interest.

FIG. 9 is an illustration of a store-map that is displayed on the user interface of the mobile device when a second product is searched for by the user, who is located anywhere inside the store.

FIG. 10 shows block diagrams of a mobile device and a server, and messages exchanges there between when advertisements are delivered to the mobile device along with high-granularity location information sent from the server.

FIG. 11 is a flowchart that shows the steps taken in locating a product when product choices are identified from a shopping list stored in the device.

FIG. 12 illustrates an exemplary shopping list.

### DESCRIPTION OF THE PREFERRED EMBODIMENTS

The word “exemplary” as used hereafter is used to mean serving as an example or illustrative instance. Any design described herein as exemplary is not meant to be the preferred or sole embodiment.

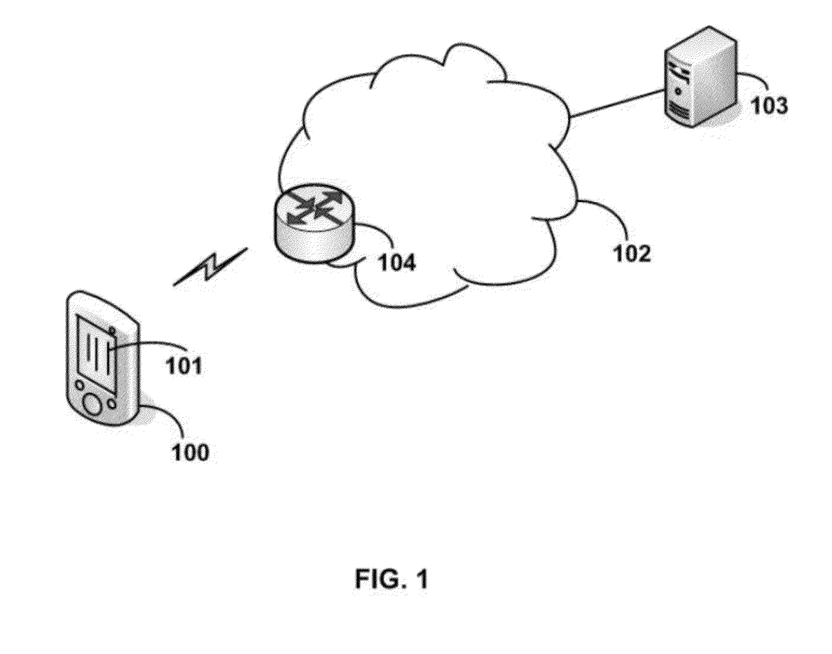

Referring now to FIG. 1, there is shown a mobile device 100 which may be cellular phone, smartphone, tablet PC, a notebook computer, an ultra-mobile PC or similar device, in accordance with one embodiment of this invention.

A product-location application 101, installed on the mobile device, would preferably operate over a wireless local area network 102 using unlicensed spectrum. Alternatively, it would operate over a mobile network conforming to the GSM, GPRS, UMTS, LTE, CDMA 2000 or IEEE 802.16 standards. The mobile device 100 communicates with a store server 103, which manages and delivers product and associated location information to mobile devices.

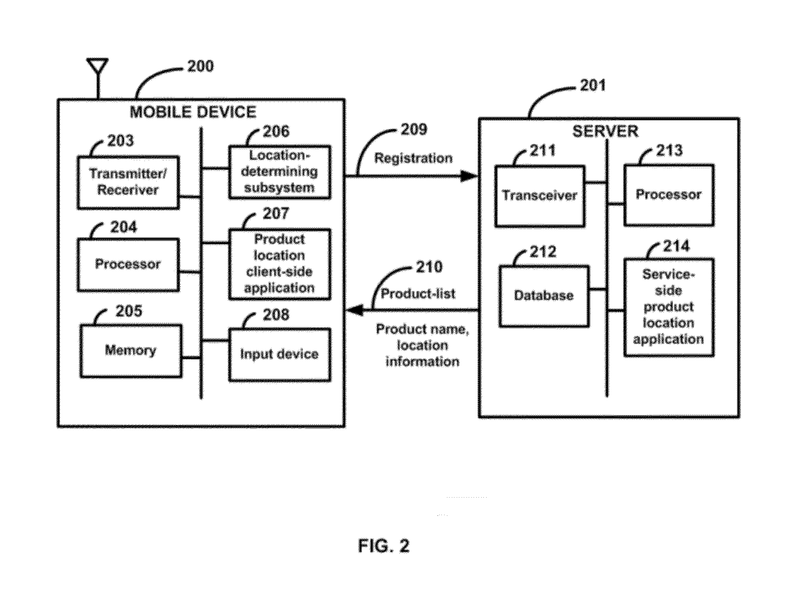

FIG. 2 is a block diagram of an exemplary design of the mobile device 200, the server 201 and the messages exchanged there-between. The mobile device 200 may be equipped with a transceiver 203 for communicating over the WLAN 102 such as, for example an IEEE 802.11 a/b/g/n, Bluetooth, ZigBee or Ultra-wideband network. Wireless local area networks are generally preferred by customers for data transmission due to the relatively higher cost of sending data over a cellular network. In addition to, local area connectivity, the mobile device 200 may also be capable of operation over a Wireless Wide Area Network (WWAN) such as GSM, GPRS, UMTS, HSPA, LTE or IEEE 802.16. Most current devices support multiple modes of operation and this trend is expected to continue in the future. In another embodiment, the transceiver 203 may only be capable of operating over a wide area network.

As shown in FIG. 2, the mobile device 200 may include at least one wireless transceiver 203, at least one processor 204 and memory 205. The wireless transceiver may be capable of transmitting and receiving information over a Wireless Local Area Network (WLAN) which may conform to any one of wireless standards such as IEEE 802.11 a/b/g/n, Bluetooth or Ultra-wideband. The wireless transceiver may communicate with the mobile device via a wireless router or similar device. Alternatively the wireless transceiver may be capable of communicating over a cellular wireless standard such as GSM, GPRS, UMTS, LTE, CDMA 2000 or IEEE 802.16. In this implementation, the mobile device 200 would communicate with the server 201 through a base station. The processor 204 may carry out local processing tasks and facilitate communication with server 201.

The mobile device 200 may also include a Location-determining Subsystem 206 that determines the current location of the mobile device 200 in the store using one of the many available position-determining methods known in the industry. The device 200 may include a Global Positioning Subsystem (GPS) that receives ephemeris data from satellites to compute the present location of the device. Alternatively, the Location-determining Subsystem 206 may utilize ephemeris data received from satellites that are part of the European Galileo system or the Russian GLONASS system. The Location-determining Subsystem 206 may instead use any one of available indoor positioning systems, cellular and WiFi triangulation methods to determine the position of the device 200 in the store. The location that is determined at the device may optionally be sent to the server 201. The device 200 may also include an input device 208 such as touch screen user interface, trackball, track pad, keys or thumb-wheel for user input. The input device may alternatively be a microphone for speech recognition.

Mobile device 200 may feature a pre-installed Product-location Client Application 207 that is designed to receive information from a store server 201 and render it on the device 100 such that it is useful to the customer. The application 207 may either be installed at the factory or downloaded from a store or other website and installed by the user. The application 207 may be capable of receiving store-specific maps and rendering each of these maps on the display screen of the mobile device 200. The mobile application 207 would preferably be a generic application which may be used by the user to receive location information in any store, retail-outlet or warehouse that the customer visits. In another embodiment, the mobile application 207 may be customized and branded for a retail chain, so that it can be used only when the customer visits stores that are part of the retail chain.

The product-location system of FIG. 2 also includes a server 201. The server may include several modules such as a transceiver 211, a database 212, a processor 213 and a Server-side Product Location Application 214. The transceiver may be capable of communicating with the mobile device over a WLAN or a WWAN. The server includes a database 212 containing product information and associated data such as inventory and location of the product in the store. The database may be maintained by store personnel. The entry and updating of the location information may also be carried out automatically. The mechanism for doing so is beyond the scope of the present invention. In an exemplary embodiment, the database may be a pre-existing database that is maintained at a store location. The server application 207 may receive the high-granularity information and derive low-granularity information and store it for transmission with the product-list. The server may also include a device location-identification unit (not illustrated) which may be used for detecting the current location of device 200. The current location of the device may be used for determining when to send high-granularity location information to the device 200 based on its location. The device-location may be identified at the server using location information received from the device 200 or through any one of the network-based location determining methods known in the art such as Angle of Arrival or Time of Arrival methods. Alternatively, device-location may be identified from location information received from a dedicated location services server that maintains current location of mobile devices within a pre-defined region.

The Server-side Product Location Application 214 may be a server application that is integrated with the database 212 and performs functions that are not limited to retrieval of product information, formatting and delivery to mobile device, as needed. The delivery of product information may be in response to a query from the mobile device 200 or triggered by the position of the device 200 within the store. In an exemplary embodiment of FIG. 2, the server 201 sends a product-list 210 to mobile device 200 after the device completes registration 209 with the server. The product-list may include at least product information such as names of products, associated location information for products specifying their location, and a store-map illustrating layout of the store.

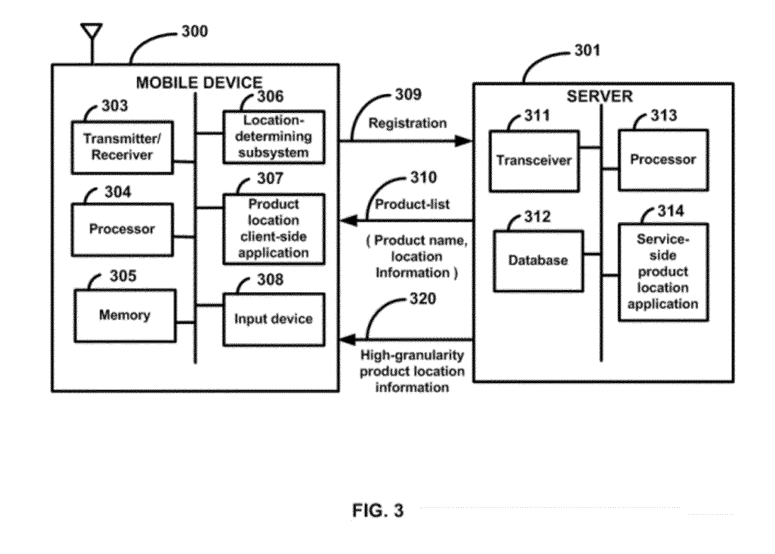

FIG. 3 illustrates an alternative embodiment, where the server 301 sends product-location information to the device 300 based on where the device is located in the store. The device 300 initially registers with server 301. Server 301 sends a product-list to the device in response to registration, where the product-list contains only the product information such as product names, low-granularity location information and the store-map. As discussed above, sending of low-granularity information helps reduce the perceived latency and thereby improves responsiveness of the application 307.

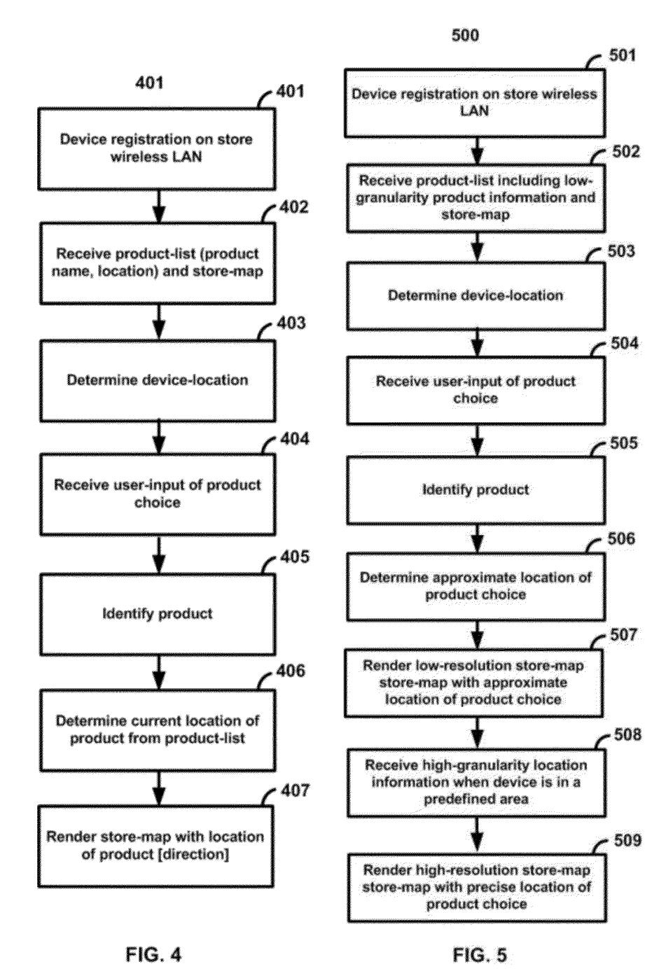

FIG. 4 shows an exemplary flowchart for a process of delivering product-location information to the mobile device 200, when a complete product list is sent to the device as the user enters the store. The method enables customers to efficiently locate a product in a store. A customer may use an entity such as mobile device 200 to accomplish the said task. The mobile device 200 may register on a store-specific wireless local area network 102 when the customer first enters the store (block 401). The wireless local area network 102 may be operated by the store or an affiliate. Registration on the WLAN 102 may be either manual or automatic. For instance, the mobile device 200 may optionally detect the present of a pre-defined wireless local area network 102 when the customer first enters a store. The identity of the predefined network 102 could be stored in the device 200 when the customized mobile application 207 is downloaded from a store website. In another aspect, the customer may search for the network 102, select and register on the network through the user-interface of the device. The device 200 would preferably be identified and authenticated on the network without much delay. This may be accomplished for instance by saving an authentication password for a retail outlet. Several alternative methods to accomplish this task are known in the art. Subsequent to registering on the WLAN or WWAN, the mobile device may register itself with the server 201. Various method of performing device validation are known in the art. The device 200 could in an exemplary embodiment send a device ID and an application ID so that the server may validate use of the Product Location Application 207 at the device.

Once the mobile device 200 registers on the network 102 and/or server 201, the server may send a product list to the device (block 402). The product list includes at least product information such as product names, high-granularity product-location information, indicating precisely where in the store the product may be located, and a store-map for the store as illustrated in one embodiment in Table 1.

TABLE 1
Sample Product list with high-granularity location information

| No. | Product name | Product-location |
|---|---|---|
| 1. | Lindt Dark Chocolate (100 g) | Aisle E; Row 4; Shelf 5 |
| 2. | Kilimanjaro Tea (500 g) | Aisle A; Row 2; Shelf 1 |
| 3. | Ginger paste (120 g) | Aisle B; Row 5; Shelf 1 |

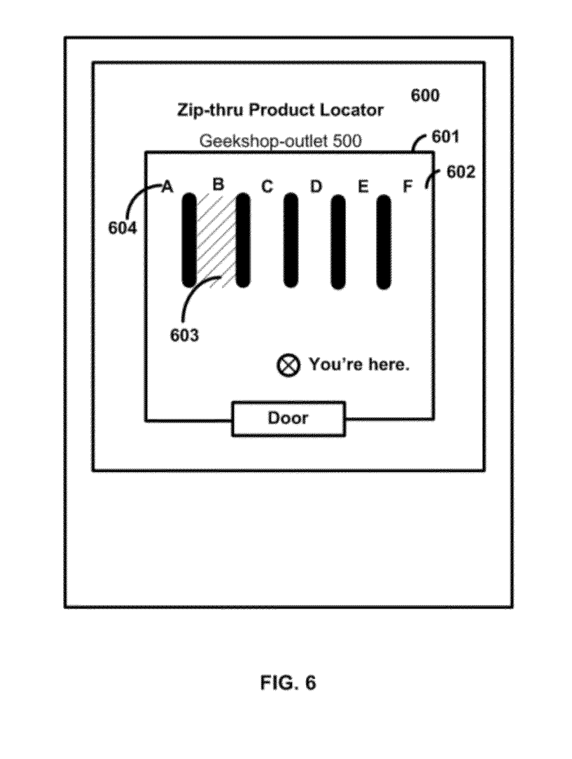

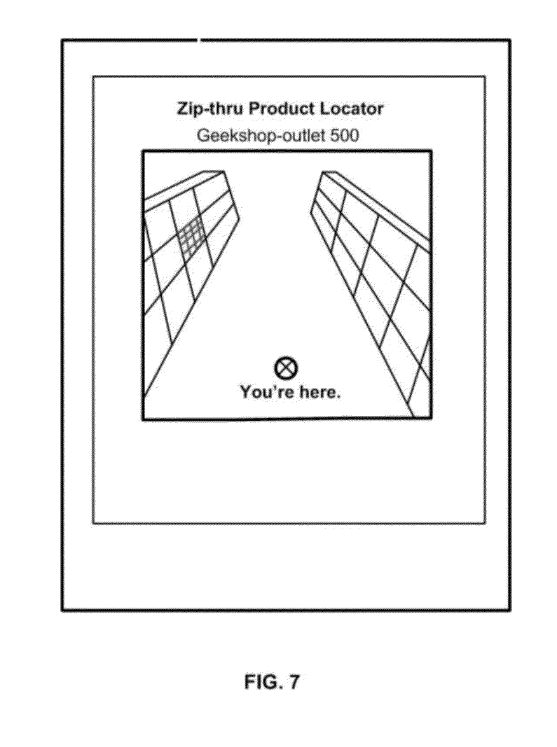

FIG. 6 is an illustrative embodiment of a store-map 602 that is displayed on the user interface 601 of the mobile device 600. The store-map 602 may contain at a minimum, a representation of the aisles 603, the aisle numbers 604, and preferably the shelves and shelf numbers. As is apparent, the store-map may be site-specific.

In addition to the store-map, the server entity in the store may send via the network, a product-list. The product-list may contain a list of all products sold at the store. Alternatively, the list may contain only the products that are currently available in the store. The product list for a retail chain would preferably be standardized so that a product is referred to only by a single name. The server may also send to the device inventory information about the product. The inventory information may vary from a basic indication as to whether the product is available or not, to details regarding the exact quantities of the products that are currently available in the store. This information would help the customer decide whether to walk further into the store to find the product or leave if the product is not currently available.

The server 201 also sends location information for the products while the device is proximate to the point of entry into the store. The location information may, in a first embodiment, comprise high-granularity location information that specifies precisely where in the store a product of choice may be located. The high-granularity location information may be sent to mobile device 200 soon after the device registers with the server 201. An example of high-granularity location information is illustrated in Table 1.

The location-determining subsystem 206 of the mobile device 200 may determine location of the device (block 403) inside the store using any one of methods mentioned above, which is generally known in the art. The current location of the user is available to the client on a near real-time basis. The device may receive user input (block 404) specifying the product choice, which is the product that the customer is trying to locate. The client application 207 may the identify the product by comparing the entered product choice with product names in the received product list (block 405). When a match is found, the application (207) retrieves location information for the product from the product-location column of the product list (block 406). The product location, in the first embodiment, comprises high granularity location information such as the aisle number, row number and shelf number in the store. The client application (207) may use the retrieved product-location information to display the store-map and render the location of the product in the store with respect to present location of the device (block 407). The application (207) may further indicate the shortest path to get the product of interest one the map.

Even though process 400 is described to be occurring as the user enters the store, it would be understood that the sending of the product list in this embodiment may occur when the device is proximate to the entrance, irrespective of whether the user is inside the store or outside.

FIG. 3 illustrates messages exchanged between the mobile device 300 and the server 301 in the second exemplary embodiment. The process is further described below. In the second exemplary embodiment (FIG. 5), the product-list that is sent to mobile device 300 soon after registration may contain low-granularity information which describes an approximate area of the store, such as a floor number, zone or section, where each of the products are located (block 502). For instance, the store may be divided into numbered aisles with location of the product being defined by the aisle number alone. Sending the product list containing just the aisle numbers, as illustrated in Table 2, would understandably reduce the amount of data that would need to be sent to the client on the device as the customer enters the store. The reduced latency would thereby result in a better customer experience. The information described above would be necessary for the customer to use the client application 307 in a satisfactory manner. In one scenario (FIG. 6), the customer may decide to search for the product “Ginger paste” and its location soon after entering the store or close to the point of entry. In that event, the received product-list containing the aisle numbers for the products would facilitate identifying an approximate area where the product choice may be found (block 506). The client application 207 may highlight the aisle where the product choice is located so that the user may move in the right direction (block 507).

TABLE 2
Sample Product list with low-granularity location information

| No. | Product name | Product-location |
|---|---|---|
| 1. | Lindt Dark Chocolate (100 g) | Aisle E |
| 2. | Kilimanjaro Tea (500 g) | Aisle A |
| 3. | Ginger paste (120 g) | Aisle B |

Further location information may be sent to the device as the customer and the mobile device 300 reach predefined areas in the store (block 508). The client application 307 may compare the user's present location with the aisle where the product of interest is located and trigger a location-based request for further information to the server 301. The server 301 may respond by sending to the device 300 high-granularity information for the predefined area, such as Aisle B. The high-granularity data would consist of information that would enable the user to precisely locate the product in the store. For instance, high-granularity information may specify the shelf number where the product is located. In an alternate embodiment, the server may identify the location of device 300 from information received from the device, a location services server or through other network-based location determining methods such as Angle of Arrival or Time of Arrival. The high-granularity information may be sent to the device 300 when the device is identified to be within a pre-defined area. Client application 307 receives the high-granularity information and renders a richer map for Aisle B (block 509). The customer thereby effortlessly reaches the product of choice without having to search for a store-attendant instead.

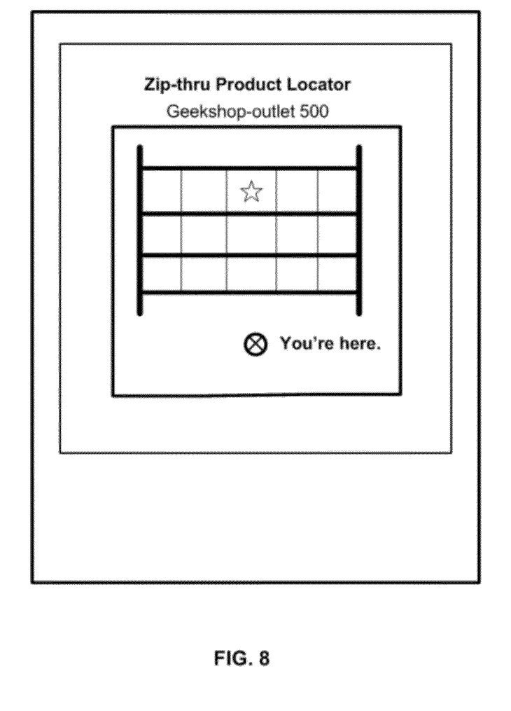

The predefined area may be better understood with reference to FIG. 6. The pre-defined area may, in one aspect, be an aisle number. For instance, as the customer walks past the entrance 607, he may search for the product, “Ginger paste”. The client application 307 may indicate that the product “Ginger paste” can be found in Aisle B (FIG. 6). The customer may then walk towards Aisle B and receive further high-granularity location information for Aisle B as he approaches the aisle. FIG. 7 illustrates an exemplary user interface view after the user reaches Aisle B and receives high-granularity location information for that aisle. The device may track the position of the user with respect to the product choice and alter the view accordingly. FIG. 8 illustrates and exemplary view where the client application 307 displays the precise location of the product in the shelf after detecting the position and orientation of the mobile device 300 with respect to that of the product of interest.

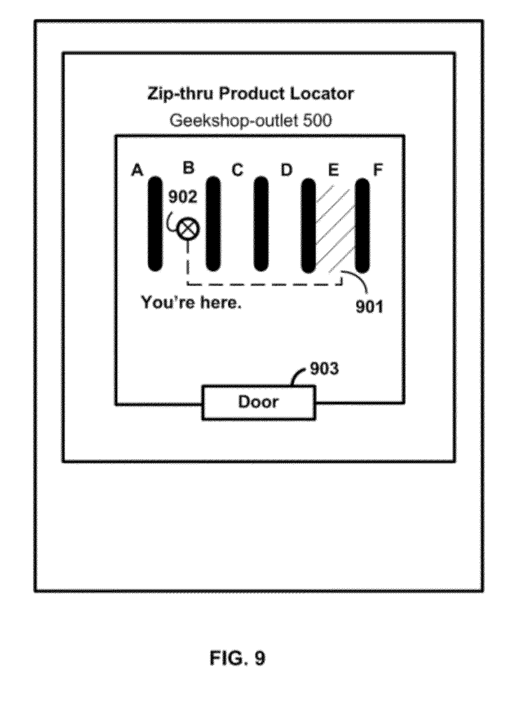

The current location of the user may be available to the client on a near real-time basis. The client application 307 may thus be able to locate a product when the customer is located anywhere in the middle of the store. For instance, after finding the product “Ginger paste” the user may decide to look for the “Lindt Dark Chocolate”. The client application 307 detects the present location of the device 901 and identifies the product-choice. When a match is found, the client application 307 determines that the product of interest is located in Aisle E. Since, device 300 has not visited Aisle E before, it can only render an approximate location of the product “Lindt Dark Chocolate”. Aisle E may be highlighted on the store-map (FIG. 9). The user may walk towards the aisle and receive high-granularity information for the products in aisle, using a client application-triggered location-based query.

In a further aspect, the high-granularity information for all the aisles and areas are sent to the device soon after the product-list is sent based on a mechanism other than a location-based trigger. This last mechanism may however lead to higher perceived latency when the data rate of the WLAN is low or/and when the store-size is very large.

Alternative methods of downloading the product-list to the mobile device 200/300 may be carried out. For instance, the product-list could, in an alternative embodiment, be downloaded to the mobile device from a store-website, prior to visiting a particular store.

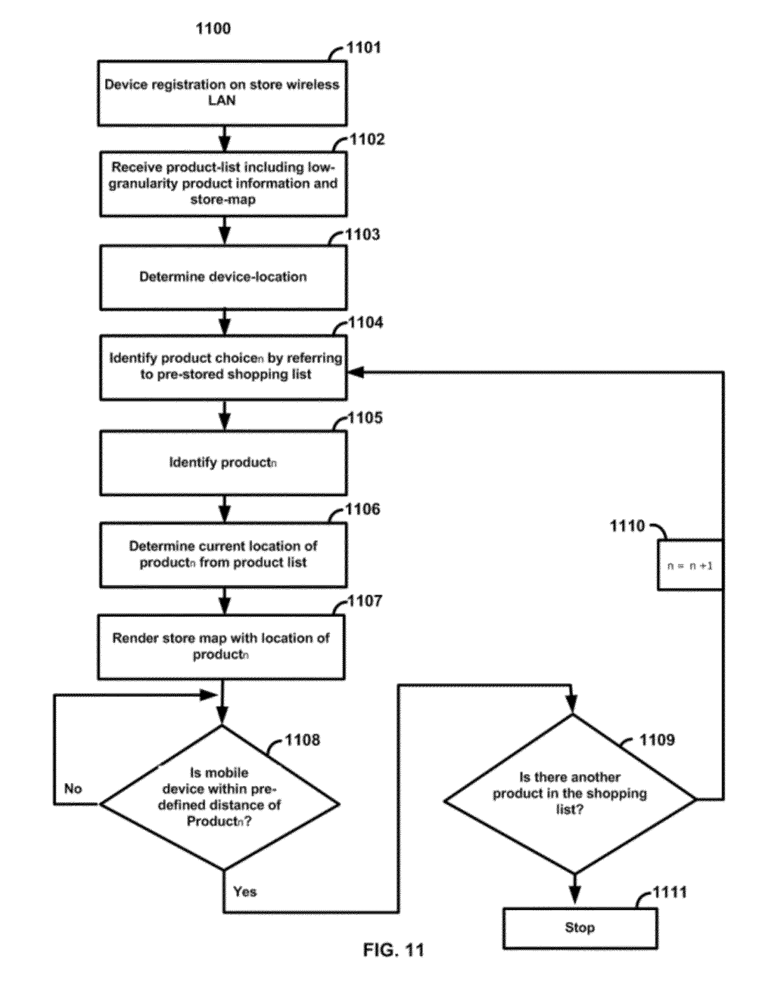

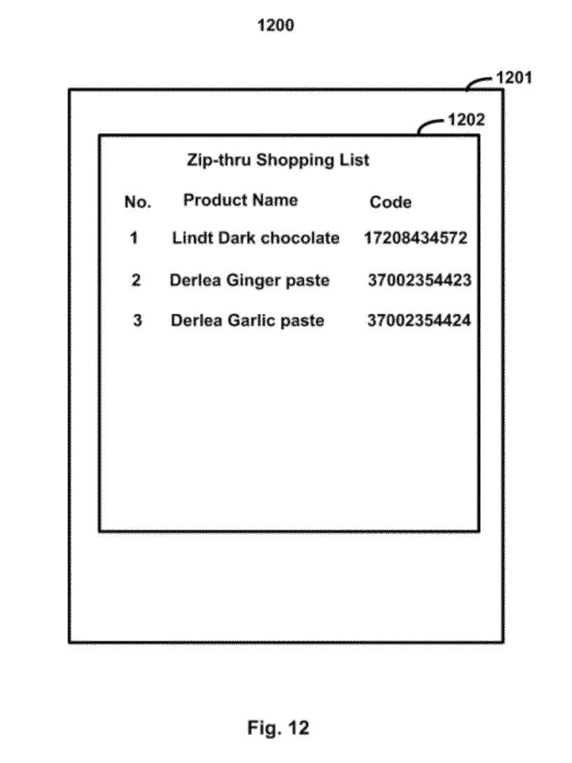

FIG. 11 illustrates another embodiment in which a user may store items that are to be purchased in a pre-stored shopping list application on the mobile device 1000. The product choice may be identified by referring to products stored in the shopping list database (block 1104). FIG. 12 illustrates an exemplary shopping list application 1202 on the mobile device 1201. The shopping list may include product names and associated product codes that aid in uniquely identifying a product. The location of the product choice may be determined and rendered on the navigation application of the mobile device using the method described in previous embodiments.

FIG. 11 illustrates another embodiment of the product locator application with an integrated shopping-list. The product-locator application identifies a first product choice, product choiceₙ from the shopping-list database and performs a search for location of productₙ using product list information that is received at the device when the user enters the store (block 1106). The current location of the productₙ is displayed on the mobile device 200 along with the location of the device 200 within the store (block 1107). Real-time location determination may be used to detect when the mobile device is within a predefined distance of the productₙ (block 1108). Upon reaching the predefined distance from productₙ, the product-location application may identify and fetch the second product choice (product choiceₙ₊₁ from the shopping list (block 1110) once it is determined that the user has successfully found the first product or product (block 1108). In the event that product choiceₙ is the last product in the shopping-list, the navigation application may stop the product search procedure and default to the home screen (block 1111). In this manner, the product-location application may function as an indoor navigation system that continuously directs the user of the mobile device to product choices listed in the shopping list. The mechanism may be used in conjunction with an automated system such as the warehouse robot developed by Kiva Systems, Massachusetts, USA. The use of an automated system would permit a user to send a shopping list to the store via e-mail or SMS so that the product choices may be pre-fetched using an automated system that runs the product-location application. It would be appreciated that product choice lookup from a shopping list may be integrated with any one of the product-list download mechanisms described in the previous section.

The product-location application may be integrated with a mobile wallet application so that a user's shopping history and product preferences may be utilized to determine the identity of an entered product choice with better precision. For instance, if the user of the mobile device enters the product name “Dark Chocolate”, historical product preference information obtained from the mobile wallet application may be used to determine that the product choice to be located is “Lindt Dark Chocolate”. The historical product preference information may include a product name, product code and/or a barcode for the product. The preference information may alternatively be obtained from a dedicated e-receipt application installed on the mobile device. The e-receipt application would store electronic copies of receipts received through short range communication with a point-of-sale terminal at the time of purchase.

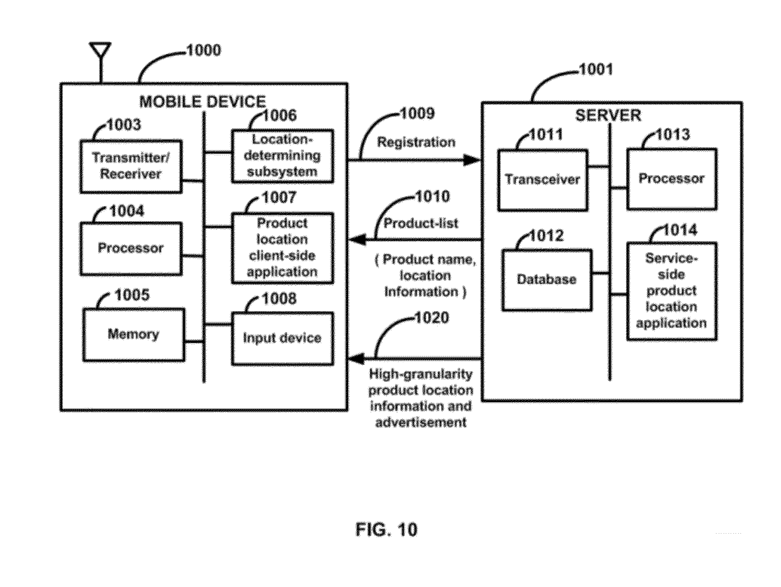

FIG. 10 illustrates a further embodiment where products other than the current product-choice that is being located may be advertised in the store map. A product to be advertised may be chosen based on the name of the product choice that is input into the device by the user. The name that is entered indicates an associated category of products, which may be chosen. Alternatively, the advertisement may be delivered based on the location of the mobile device, so that featured product may be advertised within the store as a user walks past the product. The advertisement information may optionally be transmitted as part of the high-granularity location information 1020 that is sent to the mobile device 1000.

Even though the foregoing embodiment describes the invention with reference to a network server, it would be appreciated that a mobile computing device such as a tablet or smartphone could also support the functionality of the server when the server-side application 101 is installed. The exemplary embodiments above have been primarily described in the context of wireless local area networks. However, persons skilled in the art would appreciate that variants such as a cellular network may be used without deviating from the scope of the invention as described.

1. A method of locating a product in a store, comprising the steps of:
(a) receiving at a mobile device, through a wireless local area network, a product list, the product list comprising product information for a product, associated location information for the product and a store-map for the store;
(b) determining location of the device within the store;
(c) receiving user input of a product choice at the mobile device;
(d) determining a current location of the product choice in the store from the received product list, and
(e) rendering on the store-map the location of the device and the current location of the chosen product in the store.

2. The method of claim 1 wherein the product information comprises a product name of the product sold at the store.

3. The method of claim 1 wherein the product information comprises product name of the product sold at the store and associated inventory information for the product.

4. The method of claim 3, wherein the inventory information comprises an indication as to whether the product is currently available in the store or not.

5. The method of claim 3, wherein the inventory information comprises the actual number of the product currently available in the store.

6. The method of claim 1 wherein the rendered store-map includes direction from the current location of the mobile device to the location of the chosen product.

7. The method of claim 1, wherein the location information comprises low-granularity location information, the low-granularity information indicating the approximate area where the product can be found.

8. The method of claim 7, wherein the low-granularity information is the aisle number where the product may be found.

9. The method of claim 7, wherein the low-granularity information indicates the approximate area where the product may be found.

10. The method of claim 1, wherein the product list is pre-loaded in the mobile device before the user enters the store.

11. The method of claim 1, wherein the location information comprises high-granularity location information, the high-granularity information indicating the exact location of the product.

12. The method of claim 11, wherein the high-granularity information is the aisle number and shelf number where the product can be found.

13. The method of claim 1, wherein the rendering includes rendering of the current location of the device, location of the chosen product in the store and an advertisement for a second product.

14. The method of claim 13, wherein the advertisement is selected based at least on location of the mobile device.

15. The method of claim 13, wherein the advertisement is selected based on product name of the chosen product.

16. A method of locating a product in a store, comprising the steps of:
(a) receiving at a mobile device proximate to the point of entry into the store, a product list through a wireless local area network, the product list comprising product information for a product, associated location information for the product and a store-map for the store;
(b) determining location of the device within the store;
(c) receiving further information for at least one product in the product list in response to identifying the mobile device to the be in a predefined area in the store.

17. The method of claim 16 wherein the location information comprises low-granularity location information and the further information comprises high-granularity location information identifying the exact location of the product.

18. The method of claim 16 wherein the further information comprises high-granularity location information for the predefined area.

19. The method of claim 16 wherein the predefined area is an aisle of the store.

20. The method of claim 16 wherein the further information includes an advertisement for a second product.

21. A method of locating a product in a store, comprising the steps of:
(a) receiving at a mobile device proximate to the point of entry into the store, a product list through a wireless local area network, the product list comprising product information for a product, low-granularity location information for the product and a store-map for the store;
(b) determining location of the mobile device within the store;
(c) receiving user input of a product choice at the mobile device;
(d) determining an approximate location of the product choice in the store from the received product list;
(e) rendering on the store-map the current location of the device and the approximate location of the chosen product in the store;
(g) receiving high-granularity location information in response to identifying the mobile device to be in a predefined area in the store, and
(h) rendering on the store-map the current location of the device and the high-granularity location of the chosen product in the store;

22. A mobile wireless device for determining the location of a product in a store by interacting with a store server, the mobile wireless device comprising:
(a) a processor;
(b) an input device;
(c) a location determining subsystem for determining location of the device in the store;
(d) a communication subsystem for wirelessly receiving from the store server product-location information; and
(e) a product-location application for receiving a product choice input from the input device and rendering at the mobile device the location of the device and the location of the product-choice in the store using product-location information received from the store server.

23. A method of locating a product in a store comprising the steps of:
(a) receiving at a mobile device, through a wireless local area network, a product list, the product list comprising product information for a product, associated location information for the product and a store-map for the store;
(b) determining location of the device within the store;
(c) identifying a product choice by referring to a pre-stored shopping list, the pre-stored shopping list comprising a database of products to be purchased;
(d) determining a current location of the product choice in the store from the received product list, and
(e) rendering on the store-map the location of the device and current location of the product choice in the store.

24. The method of claim 23 wherein a prior shopping history is generated based on a user's shopping pattern and the shopping history is used to precisely identify the product choice from the pre-stored shopping list.

25. The method of claim 23 wherein the prior shopping history comprises at least one of a product name, product code and a product bar code.

26. The method of claim 23 wherein the prior shopping history is obtained from a mobile wallet application.

27. The method of claim 23 wherein the prior shopping history is obtained from electronic copies of shopping receipts.

28. The method of claim 23 wherein the current location of the product choice is used for automated fetching of products listed in the pre-stored shopping list.

29. A method of locating a product in a store comprising the steps of:
(a) receiving at a mobile device, through a wireless local area network, a product list, the product list comprising product information for a product, associated location information for the product and a store-map for the store;
(b) determining location of the device within the store;
(c) identifying a first product choice by referring to a pre-stored shopping list, the pre-stored shopping list comprising a database of products to be purchased;
(d) determining a current location of the first product choice in the store from the received product list, and
(e) rendering on the store-map, the location of the device and current location of the first product choice in the store;
(f) determining that the mobile device is within a predefined distance to the first product choice and in response to the detection identifying the subsequent product in the pre-stored shopping list as a second product choice;
(g) determining the current location of the second product choice in the store; and
(h) rendering on the store-map the location of the device and the current location of the second product choice.

30. A method of locating a product in a store using a mobile device, the mobile device communicating with a server to retrieve product location information, the method comprising the steps of:
(a) sending to the mobile device through a wireless local area network, a product list, the product list comprising product information for a product, low-granularity location information for the product and a store-map for the store;
(b) identifying location of the device within the store;
(c) detecting the mobile device to be in a predefined area in the store, and
(d) sending to the device high-granularity location information for use in determining the location of a product choice in the store.

31. The method of claim 30 wherein location of the mobile device is identified from device location information received from the mobile device.

32. The method of claim 30 wherein location of the mobile device is identified through device location determination executed at the server.

33. The method of claim 30 wherein location of the mobile device is identified from device location information received from a location server.
